(19) United States
(12) Patent Application Publication
(10) Pub. No.: US 2015/0020509 A1
(43) Pub. Date: Jan. 22, 2015

(54) METHOD AND SYSTEM FOR MAXIMIZING FUEL EFFICIENCY OF AN INTERNAL COMBUSTION ENGINE

(71) Applicants: Louis A. Belanger, Peoria, AZ (US); Dean Prodromides, Grand Junction, CO (US)

(72) Inventors: Louis A. Belanger, Peoria, AZ (US); Dean Prodromides, Grand Junction, CO (US)

(21) Appl. No.: 14/261,147

(22) Filed: Apr. 24, 2014

Related U.S. Application Data
(63) Continuation-in-part of application No. 13/475,552, filed on May 18, 2012.
(60) Provisional application No. 61/815,566, filed on Apr. 24, 2013.
(60) Provisional application No. 61/822,063, filed on May 10, 2013.

(51) Int. Cl. F01N 13/08; F02M 35/10

(52) U.S. Cl. CPC F01N 13/08; F02M 35/10013; F02M 35/10118; F02M 35/10354; F01N 2470/08; F01N 2470/30; F01N 2450/40
USPC 60/323; 123/184.21; 29/888.011

(57) ABSTRACT

The exemplary embodiments herein provide a system and method for maximizing the fuel efficiency of an internal combustion engine. The system includes an insert for placement in portions of an exhaust system downstream from the header but before the muffler. Inserts can also be placed within the intake system of an internal combustion engine in order to maximize fuel efficiency. Whether placed in the exhaust or the intake, an exemplary embodiment would not affect emissions compliance of the exhaust system and combustion engine.

### CROSS-REFERENCE TO RELATED APPLICATIONS

This Application is a continuation-in-part of U.S. application Ser. No. 13/475,552 filed on May 18, 2012 and is herein incorporated by reference in its entirety. This Application also claims priority to U.S. application Ser. No. 61/815,566 filed on Apr. 24, 2013 and U.S. application Ser. No. 61/822,063 filed on May 10, 2013 both of which are herein incorporated by reference in their entirety.

### TECHNICAL FIELD

Exemplary embodiments of the invention relate to intake and exhaust system inserts from internal combustion engines (e.g., gasoline, diesel, biodiesel, compressed natural gas, alcohol, ethanol, and other similar combustion engines). More particularly, exemplary embodiments relate to the placement of an insert into an original manufacturers intake and/or exhaust system of an internal combustion engine in order to improve engine performance, including, but not limited to, fuel efficiency, emissions control, and power.

### BACKGROUND

The performance and efficiency of internal combustion engines depends on the efficient movement of gases into, through, and out of the engine, from the entrance of air into the intake system to the introduction of air and fuel through the intake ports into the cylinders of the engine to exhaust of the combustion by-products through the exhaust ports. Both the intake and exhaust systems perform critical roles in this process and have a significant impact on efficiency of the engine. The air intake system of an internal combustion engine operates to provide air into the engine by supplying oxygen to assist in the combustion of the fuel. Ideally intake systems increase the velocity and density of the air that travels into the combustion chamber of the engine. Modern intake systems can be highly complex and often include specially designed intake manifolds to optimally distribute air and air/fuel mixture to each cylinder. The exhaust system operates to provide complete and efficient removal or scavenging of the exhaust gases from the cylinder. One method employed to increase the removal of gas exhaust from the cylinder is to increase the flow potential of the exhaust system by increasing or decreasing the dimensions of the exhaust components.

A typical intake system from an original manufacturer has an intake manifold connected to the intake ports on the engine block, a throttle body or carburetor, and air induction components including, an air cleaner (filter), a housing, and solid or flexible duct tubing. The air enters the duct tubing and passes through the air filter, more duct tubing then passes the air to the throttle body and from there into the intake manifold to the engine intake ports. Other original manufacturer and aftermarket intake systems also include both turbocharger and superchargers. A turbocharger is a forced induction device that forces more air into the combustion chamber of the engine to produce more power. A supercharger is mechanically driven forced induction system.

A typical exhaust system from an original manufacturer has an exhaust manifold that includes a flange, conduits, and a collector. The exhaust flange includes an appropriate number of openings for coupling to the engine exhaust ports. For example, in a four cylinder engine the flange would include four openings, one for each cylinder. A conduit is provided for each opening in the exhaust manifold. The conduits then converge into a collector. In original manufacturer exhaust systems, the conduits have a short run length typically measured in inches. Other original manufacturer exhaust systems may eliminate these short conduits and the exhaust gas travels directly from the cylinder, through the flange into a collector where it then enters the exhaust pipe. Still other exhaust systems have the exhaust manifold cast directly into the cylinder head creating a unitary design.

To increase the horsepower in race cars, exhaust “header” systems have been used. A conventional exhaust header comprises a plurality of individual elongated tubes for coupling each of the cylinder heads of an engine block to a remote collector. These remote collectors may be upwards of two feet from the cylinder exhaust port. In header systems, adjacent exhaust ports in the engine block are isolated by the separate header tubes in order to increase the engine's horsepower. To further increase the horsepower of race cars, inserts have been used in the remote collector of these header systems; although those skilled in the art continue to debate the effectiveness of exhaust inserts in a race car header system.

### SUMMARY OF THE GENERAL INVENTIVE CONCEPT

Exemplary embodiments of the inventive concept are based on the unexpected results achieved and features discovered when attempting to incorporate exhaust inserts into original manufacturer exhaust systems. While exhaust inserts were used to increase horsepower in race cars with headers specifically designed for inclusion of an exhaust insert it was believed, by those skilled in the art, that exhaust inserts would produce detrimental results when applied to stock exhaust systems. Those of ordinary skill in the art cited several reasons including throttle conditions, differing computer systems and the physical length of racing headers which are much longer and tuned differently from stock exhaust manifolds for the expectation that exhaust inserts would produce a detrimental effect on stock exhaust systems.

Race cars and standard stock cars are operated under extremely different conditions. Generally, race cars include modifications to increase horsepower and are operated under wide open throttle (“WOT”) conditions. In WOT conditions the engine is maintained at very high rotations per minute (“RPM”) to maximize speed in the racing environment. The continuous WOT increases the air flow into and out of the engine. Conversely, stock automobiles such as those readily available to the public and operated on public highways are driven under steady state driving conditions. Under steady state driving conditions the car is operated within normal traffic laws, and in city driving must make frequent stops where the engine is merely idling. Those of ordinary skill in the art believed insertion of an exhaust insert would cause poor engine performance and result in stalling at the engine while idling. This expectation proved to be false as was discovered during testing of an exhaust insert in stock exhaust systems. Unexpectedly the exhaust insert, if properly configured, had no detrimental effect on stock exhaust systems. Rather, after testing stock exhaust systems with exemplary embodiments of the exhaust inserts, it was discovered that the vehicles fuel efficiency increased significantly. This increase in fuel efficiency had a significant positive impact on the gas mileage of the stock vehicle with the exhaust inserts. The discovery that exhaust inserts in stock exhaust systems provided a substantial increase in fuel mileage was unexpected.

Furthermore, those of skill in the art believed that the computer operating systems of stock vehicle versus race cars would prevent the inclusion of exhaust inserts into stock exhaust systems. Race cars typically have a custom user identified open loop computer system. The open loop computer system is programmed to maximize the power output of the engine by optimizing air to fuel ratios typically around 12:1 when using gasoline as fuel to increase the horsepower of the race car irrespective of emissions. Stock vehicles on the other hand have a closed loop computer system. The closed loop computer systems on stock vehicles today have a feedback control loop focusing on emission control parameters by controlling the air to fuel ratio to stoichiometric (e.g., 14.7 to 1 when using gasoline as fuel) rather than simply increasing engine performance. The feedback control loop includes sensors throughout the exhaust system to ensure optimal emissions standards are maintained.

Typically, when stock exhaust systems are modified, the sensors of the feedback control loop detects the emission change and indicates to the user that a problem exists in the engine emission control system. This usually necessitates the alteration or removal of sensors from the feedback control loop. In addition, modifications that trip the sensors or necessitate removal or modification of the sensors of the feedback control loop will void the manufacturer's warranty and is illegal to operate on public roads. However, when testing was conducted on the exhaust insert described herein, it was discovered that it was not necessary to alter the existing feedback control loop. Unexpectedly, the insertion of the exhaust insert into the stock exhaust system did not adversely affect the emissions enough to register on the sensors of the feedback control loop, and testing has shown a reduction in unwanted emissions. Therefore, the exhaust insert described herein, unexpectedly works in stock exhaust systems to increase fuel mileage while maintaining or improving proper emissions.

Generally, the exemplary embodiments described herein provide for an exhaust insert for insertion into a stock exhaust system to increase fuel efficiency. Typical stock exhaust manifolds include a flange, conduits and a collector. The flange is attached to the engine and has holes aligned with the exhaust gas ports on the engine. Conduits are attached to the flange and transport the exhaust gas to a collector where the exhaust gas from the conduit's path comes together.

The exemplary exhaust gas management insert (“exhaust insert”) may be an object of any shape, size or material that occupies internal volume of the exhaust manifold and is located in the exhaust manifold between the exhaust port and before and/or after the catalytic converter. In other exemplary embodiments, the exhaust insert may be located at any point between the exhaust port and the exhaust tip. Exemplary embodiments of the inventive exhaust insert increases the performance of an internal combustion engine, as used herein performance includes increased fuel efficiency, power output including both horsepower and torque, while still maintaining emissions compliance.

The exemplary exhaust insert is affixed inside the exhaust manifold. The exhaust insert may be affixed to or mounted downstream from the conduits and extend into the collector before and/or after the catalytic converter. The exhaust insert may be affixed to the conduits by casting, welding, epoxies, adhesives or mechanical fastening methods. Although different exhaust inserts may vary in shape, generally exhaust inserts have a body having a longitudinal axis, a first end, and a second end. The second end may be shaped to optimize the exhaust gas exiting the conduits.

In still other exemplary embodiments, the exhaust insert may not be affixed to components of the stock exhaust manifold, but rather suspended by a collar having cross-members. In this embodiment, the collar may be shaped to securely fit inside the conduits, collector, or the exit aperture of the collector. The cross-members extend inward from the collar and intersect with the exhaust insert. This configuration allows for extremely easy installation of an exhaust insert into an existing stock exhaust manifold.

In still other exemplary embodiments, the exhaust insert may be movable within the exhaust manifold. In this embodiment, sensor readings may be taken to determine whether the exhaust insert(s) need to be moved upstream and/or downstream to maintain optimal fuel efficiency depending on the exhaust insert(s) location.

In some embodiments, the inserts may be formed as a unitary portion of two sides which are joined together. In this embodiment, the device preferably contains a first side having a rounded exterior surface and a substantially planar inner surface. The device also contains a second side having a rounded exterior surface and a substantially planar inner surface. A negative impression is preferably formed within both of the substantially planar inner surfaces. The negative impressions may define a conical, trapezoidal, or pyramid shape when the two substantially planar inner surfaces are aligned with one another and the two sides are joined together. A cap may be placed on the shape which is formed by the two negative impressions.

In additional exemplary embodiments, the exhaust inserts may be inserted into each pipe leading from the cylinder exhaust ports, before and after collectors, before and after catalytic converters, before and after any Y-pipe present in the exhaust system, and any other location in the exhaust system. In embodiments having multiple exhaust inserts, the exhaust inserts may be arranged serially, one after another, to optimize exhaust gas flow.

In still other exemplary embodiment, the inserts, in all forms, may be used in the intake system of an internal combustion engine. In this embodiment, the insert is placed at any point along the intake system. Accordingly, the insert may be placed before the air filter, after the air filter, before or after the throttle body, in the intake manifold or in any intake ports in the engine itself. In addition, the inserts may be moveable within the intake system depending on the throttle position. Furthermore, depending on the needs of the engine, multiple inserts may used in the intake system arranged in series and having individual inserts for each cylinder in the intake manifold or in each intake port in the engine. The inserts could also be used in intake systems having turbochargers or superchargers.

### BRIEF DESCRIPTION OF THE DRAWING(S)

In addition to the features mentioned above, other aspects will be readily apparent from the following descriptions of the drawings and exemplary embodiments, wherein like reference numerals across the several views refer to identical or equivalent features, and wherein:

FIG. 1 is a perspective view of an exemplary embodiment of an exhaust insert for increasing engine performance, including fuel efficiency, located in the collector of an original manufacturer's exhaust manifold with portions removed to show the internal placement of the exemplary exhaust insert;

FIG. 2 is an enlarged perspective view of an exemplary embodiment of an exhaust insert for increasing engine performance, including fuel efficiency, located in the collector of an original manufacturer's exhaust manifold with portions removed to show the internal placement of the exemplary exhaust insert;

FIG. 3 is a close-up end view of an exemplary embodiment of an exhaust insert for increasing engine performance, including fuel efficiency, located in the collector of an original manufacturer's exhaust manifold with portions removed to show the internal placement of the exemplary exhaust insert;

FIG. 4 is a side view of an exemplary embodiment of a rounded exhaust insert to be placed in an original manufacturer's exhaust system for increasing engine performance, including fuel efficiency, of an internal combustion engine;

FIG. 5 is another side view of an exemplary embodiment of a rounded exhaust insert to be placed in an original manufacturer's exhaust system for increasing engine performance, including fuel efficiency, of an internal combustion engine;

FIG. 6 is a top perspective view of an exemplary embodiment of an elongated tetrahedron exhaust insert to be placed in an original manufacturer's exhaust system for increasing engine performance, including fuel efficiency, of an internal combustion engine;

FIG. 7 is a top perspective view of an exemplary embodiment of an elongated square pyramidal exhaust insert to be placed in an original manufacturer's exhaust system for increasing engine performance, including fuel efficiency, of an internal combustion engine;

FIG. 8 is a top perspective view of an exemplary embodiment of a crimped, tapered exhaust insert to be placed in an original manufacturer's exhaust system for increasing engine performance, including fuel efficiency, of an internal combustion engine;

FIG. 9 is a top perspective view of an exemplary embodiment of a plug exhaust insert to be placed in an original manufacturer's exhaust system for increasing engine performance, including fuel efficiency, of an internal combustion engine;

FIG. 10 is a perspective view of an exemplary embodiment of an exhaust insert to be placed in an original manufacturer's exhaust system for increasing engine performance, including fuel efficiency, of an internal combustion engine;

FIG. 11 is a perspective view of an exemplary embodiment of a removable exhaust insert for increasing engine performance, including fuel efficiency, located pre-catalytic converter in an original manufacturer's exhaust manifold with portions removed to show the internal placement of the exemplary exhaust insert;

FIG. 12 is a top perspective view of an exemplary embodiment of an exhaust insert to be placed in an original manufacturer's exhaust system for increasing engine performance, including fuel efficiency, of an internal combustion engine;

FIG. 13 is a perspective view of an exemplary embodiment of an exhaust insert for increasing engine performance, including fuel efficiency, located in the exhaust system of an internal combustion engine at the Y-pipe just before the inlet to the muffler in the exhaust system of an internal combustion engine;

FIG. 14 is a top perspective view of another exemplary embodiment of an exhaust insert for increasing engine performance, including fuel efficiency, located in the exhaust system of an internal combustion engine at the Y-pipe just before the inlet to the muffler in the exhaust system of an internal combustion engine;

FIG. 15 is a top view of an exemplary exhaust manifold designed to take advantage of the exemplary exhaust inserts for increasing engine performance of an internal combustion engine;

FIG. 16 is a top perspective view of an exemplary embodiment of an exhaust insert for increasing engine performance, including fuel efficiency, having a multi-part design for placement in an exhaust system of an internal combustion engine;

FIG. 17 is a top perspective view of the exemplary exhaust insert of FIG. 16, without the end cap;

FIG. 18 is a perspective view of the exemplary components used to form a portion of the exemplary exhaust insert of FIG. 16;

FIG. 19 is a perspective view of an exemplary embodiment of an exhaust insert for increasing engine performance, including fuel efficiency, for placement in an exhaust system of an internal combustion engine;

FIG. 20 is a top perspective view of the exemplary components used to form a portion of the exemplary exhaust insert of FIG. 19;

FIG. 21 is a perspective view of an original intake system in which an insert may be placed to increase engine performance and fuel efficiency;

FIG. 22 is a schematic drawing of an exhaust system illustrating insert placement with respect to a catalytic converter;

FIG. 23 is a schematic drawing of an exhaust system having dual, in-line catalytic converters and illustrating insert placement related thereto; and

FIG. 24 is a schematic drawing of an exhaust system having dual, in-line catalytic converters and illustrating insert placement related thereto.

### DESCRIPTION OF THE REFERRED EMBODIMENT(S)

The inventive concept will now be described more fully hereinafter with reference to the accompanying drawings, through which some, but not all possible embodiments of the invention are shown. Indeed, the inventive concept may be embodied in various forms and should not be construed as limited to the particular embodiments set forth herein.

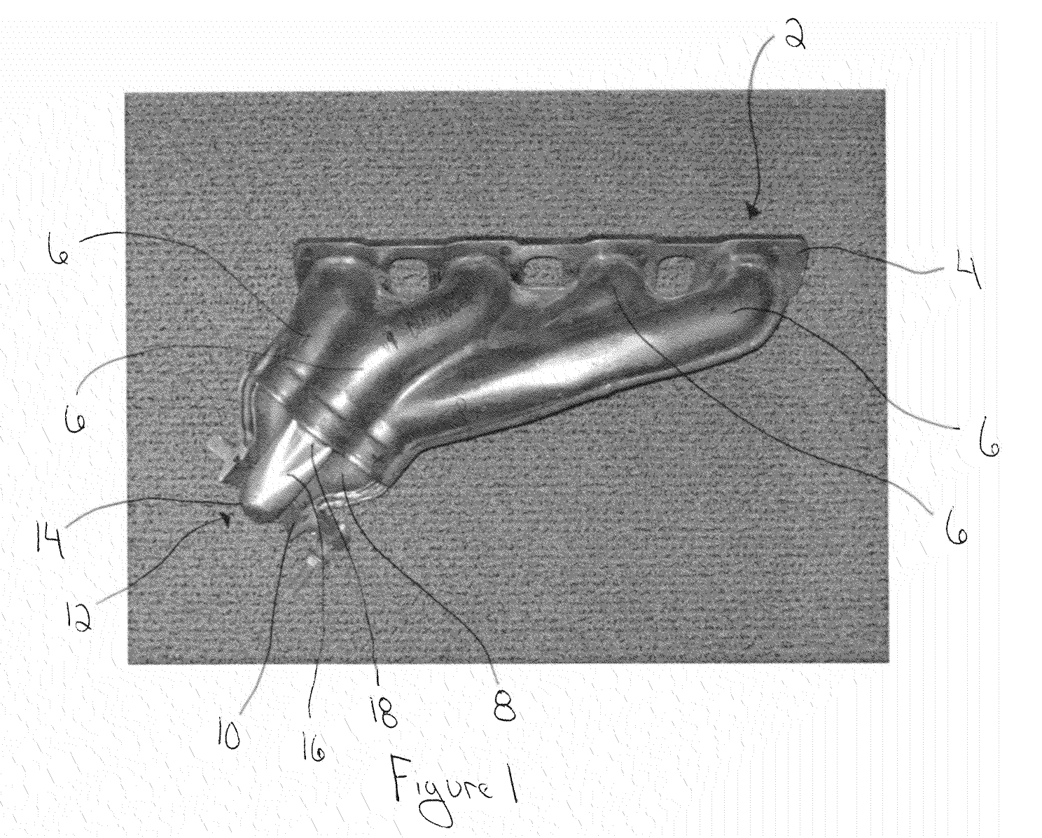

FIG. 1 is a perspective view of an original manufacturer exhaust system 2. As shown in FIG. 1, the exhaust system 2 includes a flange 4, conduits 6 and a collector 8. The flange 4 is formed to the dimensions and shape of the engine (not shown in the Figures) to which it is to be attached. As shown in FIG. 1, the flange 4 may be coupled to the engine with mechanical fasteners, such as bolts. The conduits 6 extend from the flange 4 to the collector 8. The conduits 6 may be of varying length depending on the space available in the engine compartment. The flange 4 has openings therein to allow exhaust gas from an engine's cylinders to pass through the flange 4 and enter the conduits 6. The exhaust gas flowing thorough the separate conduits 6 enter one common flow path defined by the collector 8. The collector 8 may include an exit aperture 10. From the collector 8, the exhaust gas travels out the exit aperture 10 and into the exhaust pipe which typically includes a catalytic converter 700 (shown in FIGS. 22-24) and exits the exhaust pipe through a muffler.

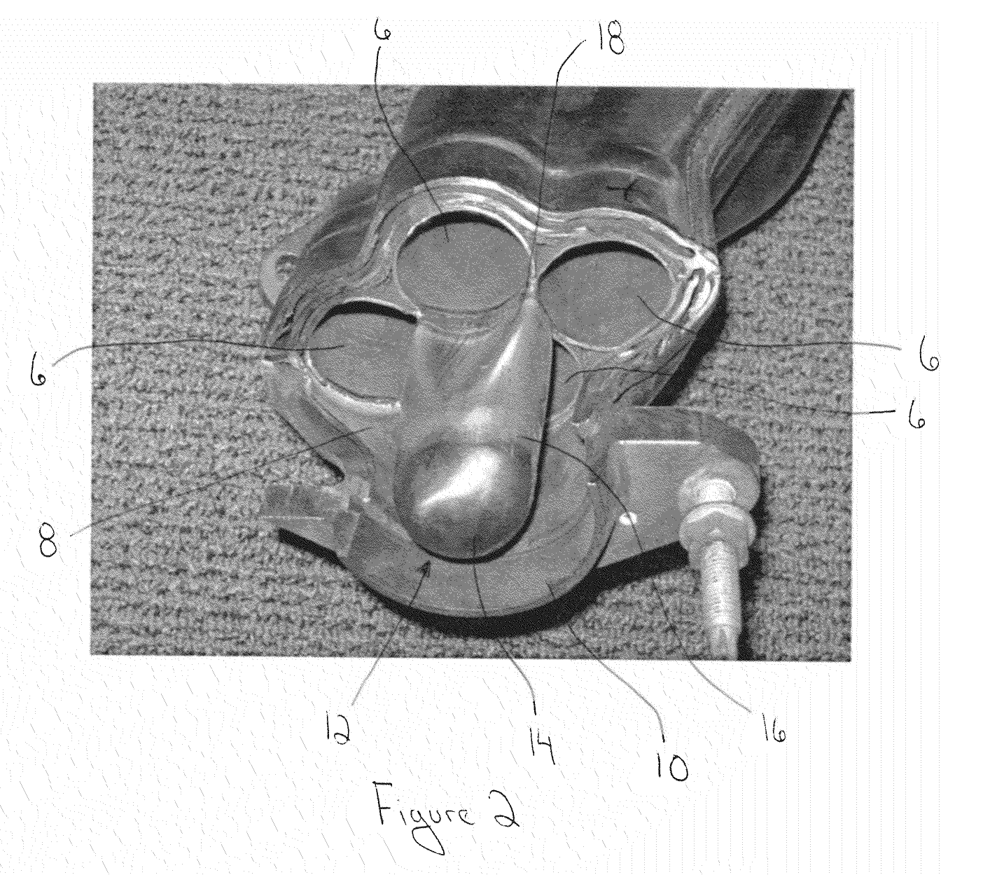

As further shown in FIG. 1, an exemplary embodiment of an exhaust insert 12 is positioned in the collector 8. As shown in FIG. 1, the exhaust insert 12 may have an elongated body 14 having a rounded first end 16 and a second end 18. The exhaust insert 12 may be constructed from metal, ceramic, plastic, or other similar materials capable of withstanding the temperatures present in typical exhaust systems. In addition, the exhaust insert 12 may be hollow to decrease its weight. In other exemplary embodiments, the exhaust insert 12 may be solid. The exhaust insert 12 is attached to the conduits 6 at the second end 18. This attachment is illustrated in FIG. 2.

FIG. 2 is an enlarged perspective view of an original exhaust manifold 2 illustrating an exemplary embodiment of the exhaust insert 12. As shown in FIG. 2, the second end 18 of the exhaust insert 12 is welded to the conduits 6. While welding enables for attachment of the exhaust insert 12 to the conduits 6, other methods of attachment are also contemplated, including, but not limited to, epoxies, mechanical fasteners, press in fit, and other similar attachment methods. In other exemplary embodiments, the exhaust insert 12 may be cast directly into place. Affixing the exhaust insert 12 to the conduits 6 as they enter the collector 8 allows for easy retro fitting of existing stock exhaust systems and during the manufacturing process. As shown in FIG. 2, the second end 18 of the exhaust insert 12 may be shaped to optimize the exhaust insert's 12 direct interference with the exhaust gas exiting the conduits 6. The exhaust insert 12 extends from the conduits 6 into the collector 8. The exhaust gas exiting the conduits 6 and entering the collector 8 is forced to travel around the exhaust insert 12 before exiting the collector 8 into the exhaust pipe. The exhaust insert 12 may have a pre-determined volume sized to maximize fuel efficiency of the engine while maintaining or increasing engine power and maintaining or decreasing emissions. Such size and shape of the exhaust insert 12 can be varied according to the desired results in order to maximize economy, power, emissions, or some combination of thereof.

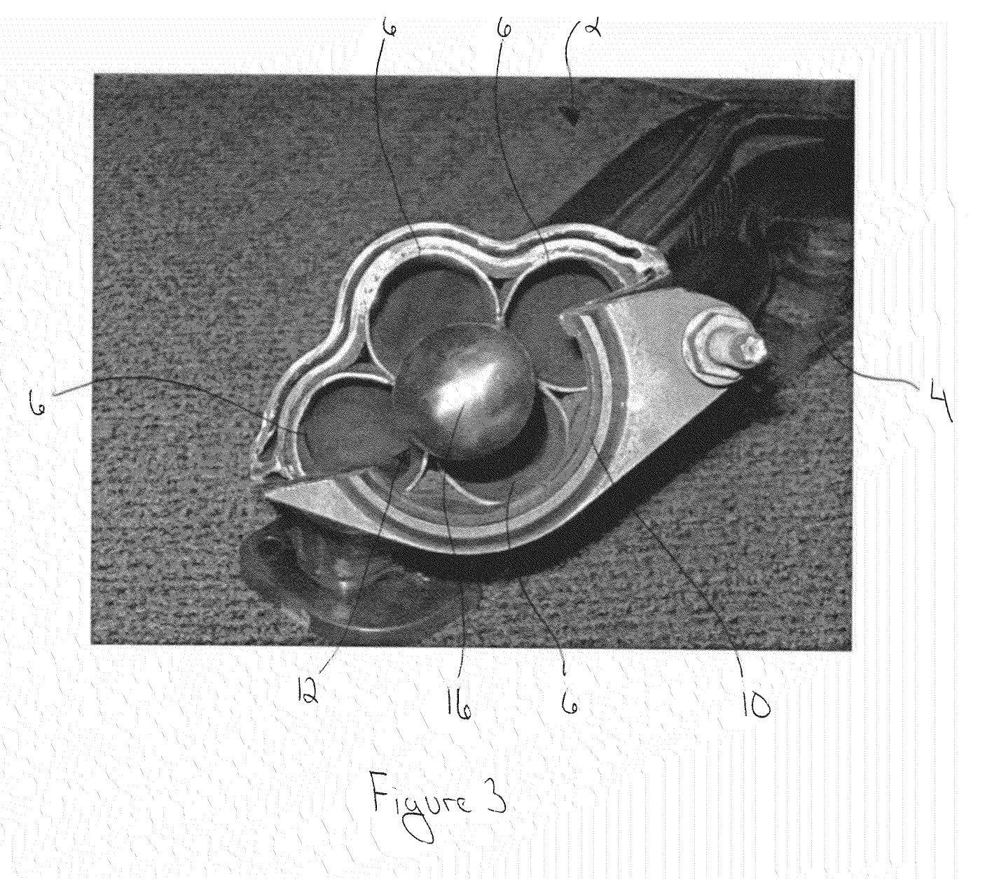

FIG. 3 is another view of the original exhaust manifold 2 having an exemplary embodiment of the exhaust insert 12. As shown in FIG. 3, the exhaust insert 12 may be centered in the collector 8 either abutting the conduits 6 or spaced downstream therefrom. In other exemplary embodiments, the exhaust insert 12 may be positioned off-center or against the side of the collector 8 depending on the configuration of the stock exhaust system. The exhaust insert 12 may have a pre-determined volume dependant on the size of the motor, exhaust pressures, volume of the collector 8, and desired engine performance, including fuel efficiency. As shown in FIGS. 1-3, the exhaust insert 12 decreases the volume of exhaust gas that can be in the collector 8. In other exemplary embodiments, the exhaust insert 12 may be placed at any location in the exhaust manifold upstream and/or downstream of the catalytic converter 700. In still other exemplary embodiments, an exhaust insert 12 may also be placed in each conduit 6, with or without the exhaust insert 12 in the collector 8.

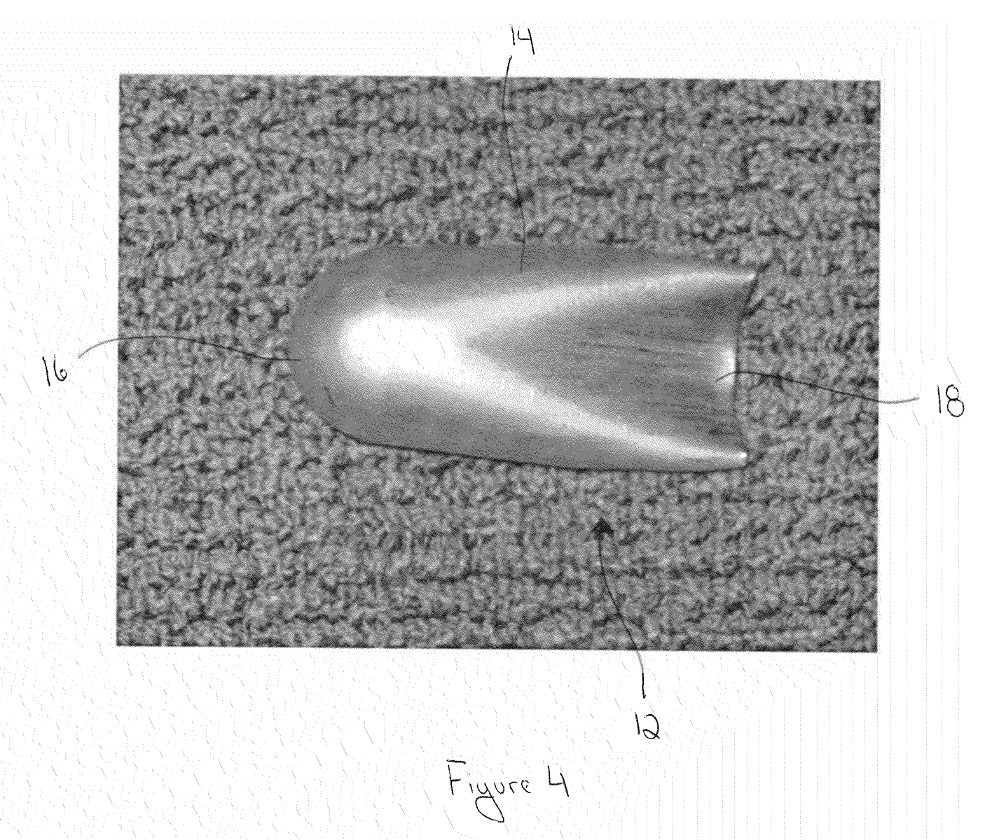

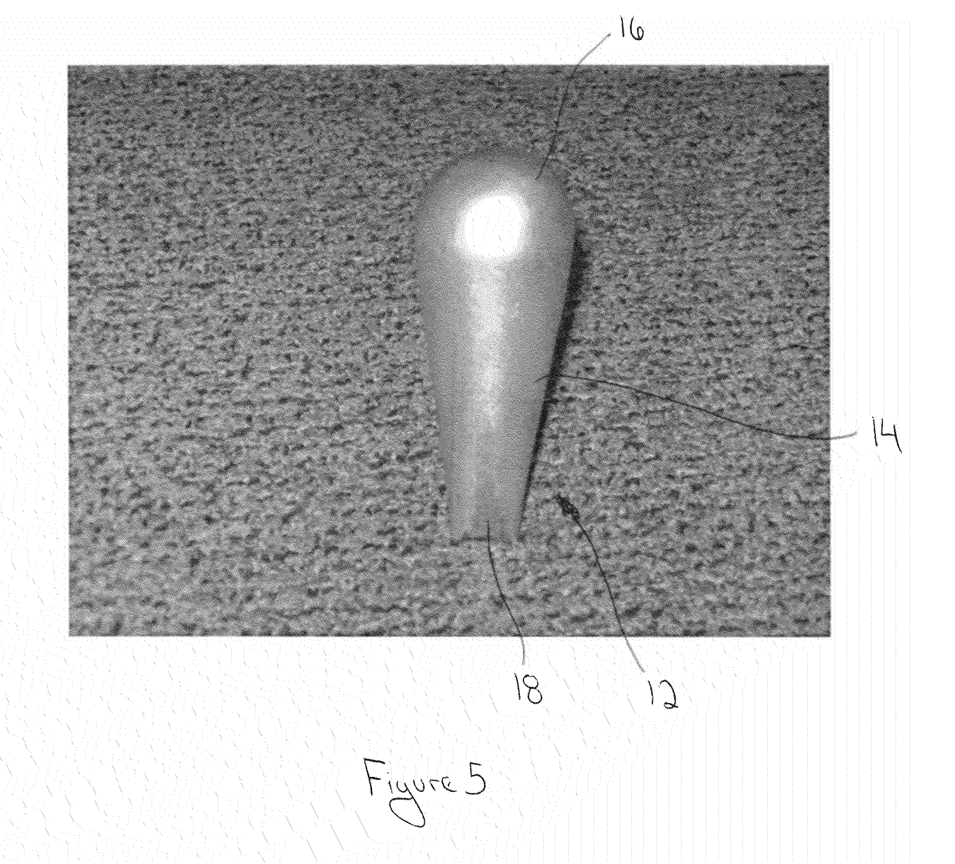

FIG. 4 is a side view of the exemplary embodiment of a rounded exhaust insert 12. As shown in FIGS. 1-4, the exhaust insert 12 has an elongated body 14 having a longitudinal axis, a rounded first end 16 and a second end 18. As shown in FIG. 4, the second end 18 of the exhaust insert 12 may be shaped so as to optimize with the exhaust gas exiting the conduits 6. This can be accomplished by indenting or shaping the second end 18 so that the exhaust insert 12 can be brought into complimentary engagement with the conduits 6 upon entry into the collector 8. FIG. 5 is another side view of an exemplary embodiment of the rounded exhaust insert 12 further illustrating the indentions in the second end 18 of the exhaust insert 12. Although FIGS. 1-5 provide for an exemplary embodiment of the exhaust insert 12 having a rounded first end 16, other shapes may be used to compliment the original manufacturer's conduit 6 configuration, collector 8 size and shape, and the desired fuel efficiency.

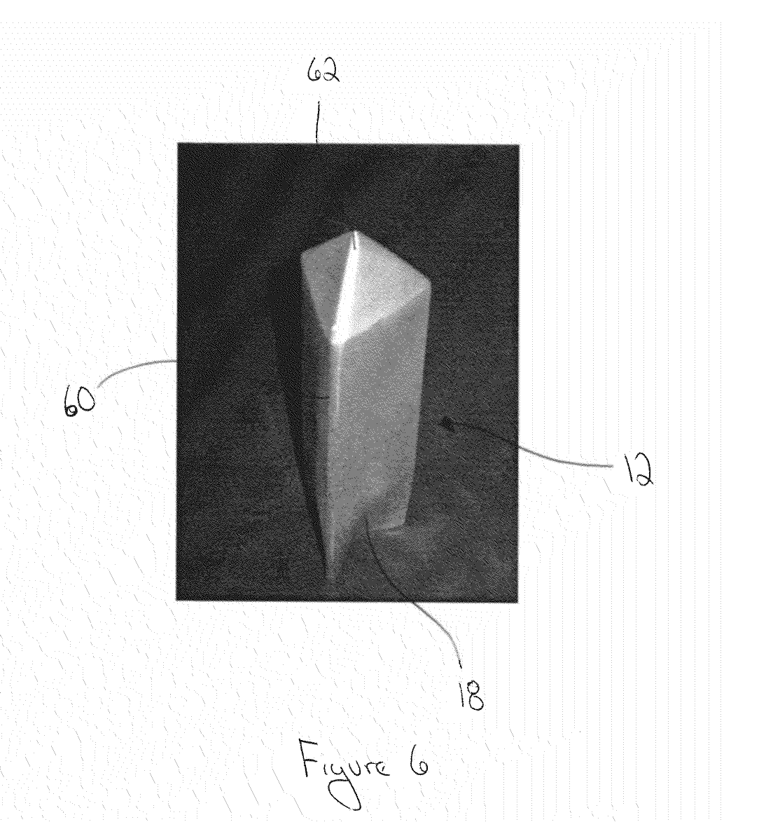

FIG. 6 is a top perspective view of an alternative exemplary embodiment of an exhaust insert 12 with a three-sided elongated body 60 having a longitudinal axis, a tetrahedral first end 62 and a second end 18. The three-sided body 60 of the exhaust insert 12 illustrated in FIG. 3 may be used on original manufacturer's exhaust systems having three conduits 6, such as found in V-6 engines. As with other exemplary embodiments, the second end 18 may be shaped so as to optimize the interference with the exhaust gas exiting the conduits 6.

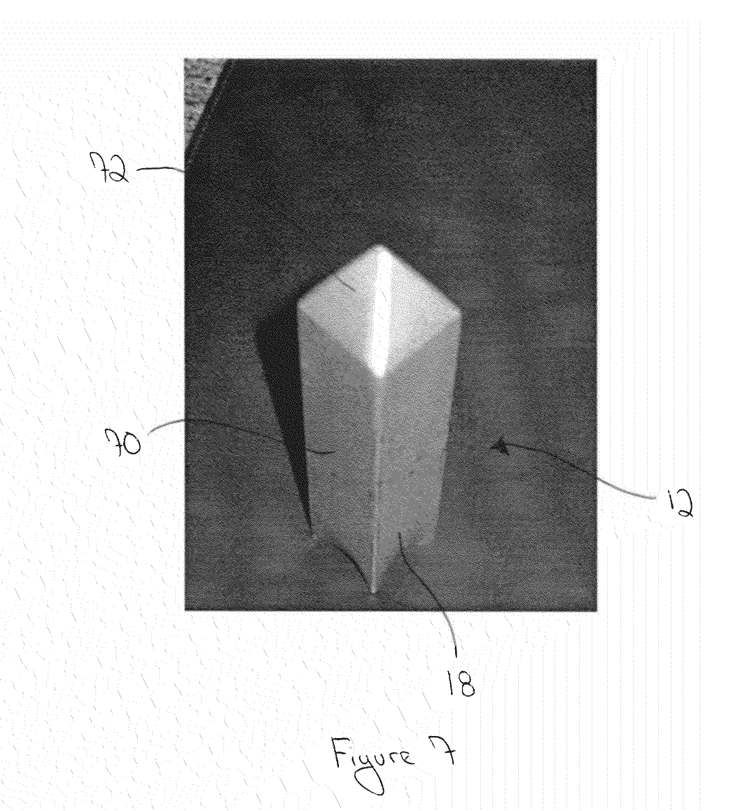

FIG. 7 is a top perspective view of another exemplary embodiment of an exhaust insert 12 with a four-sided elongated body 70 having a longitudinal axis, a square pyramidal first end 72, and a second end 18. The four-sided body 70 of the exhaust insert 12 illustrated in FIG. 7, may be useful in original manufacturer's exhaust systems having four conduits 6, such as found in V-8 engines. As with all exemplary embodiments the second end 18 may be shaped so as to optimize the exhaust gas exiting the conduits 6.

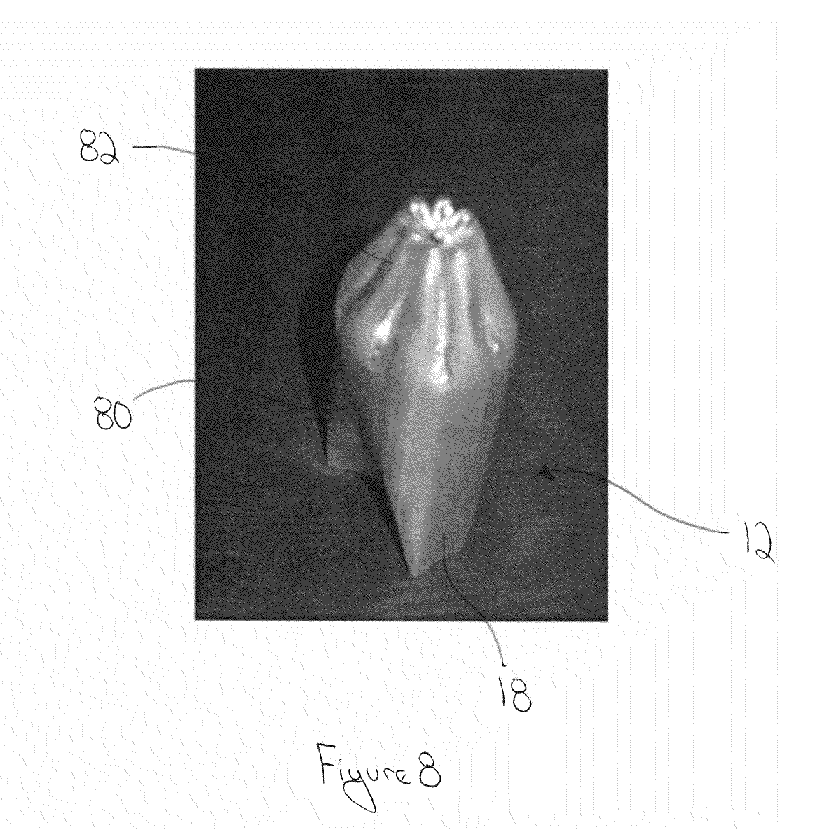

FIG. 8 is a top perspective view of another exemplary embodiment of an exhaust insert 12 with an elongated body 80 having a longitudinal axis, a crimped first end 82, and a second end 18.

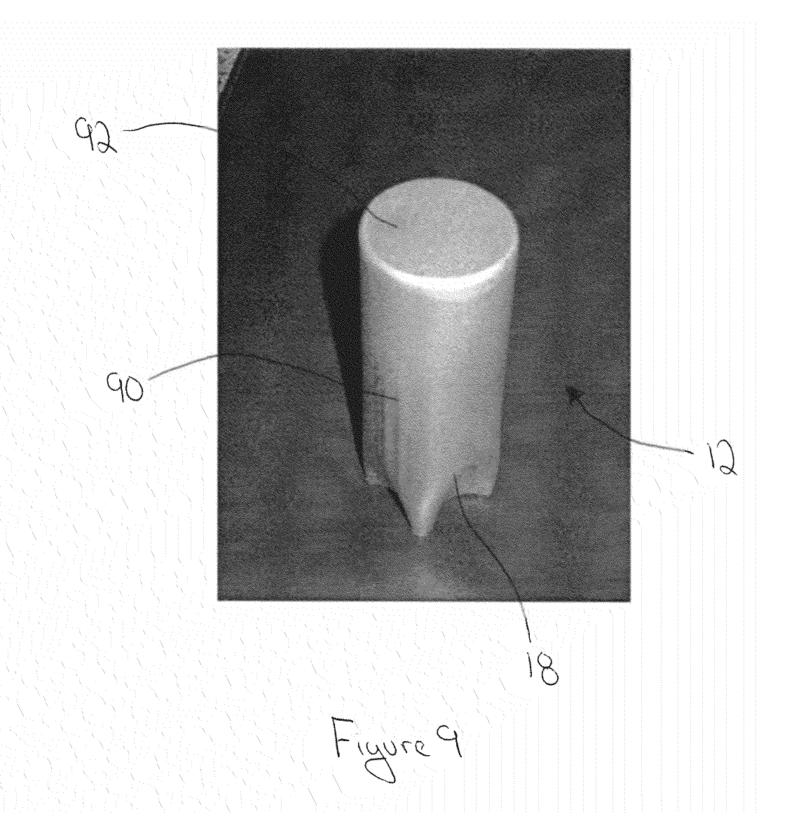

FIG. 9 is a top perspective view of yet another exemplary embodiment of an exhaust insert 12 having a cylindrical elongated body 90, a flat first end 92 and a second end 18.

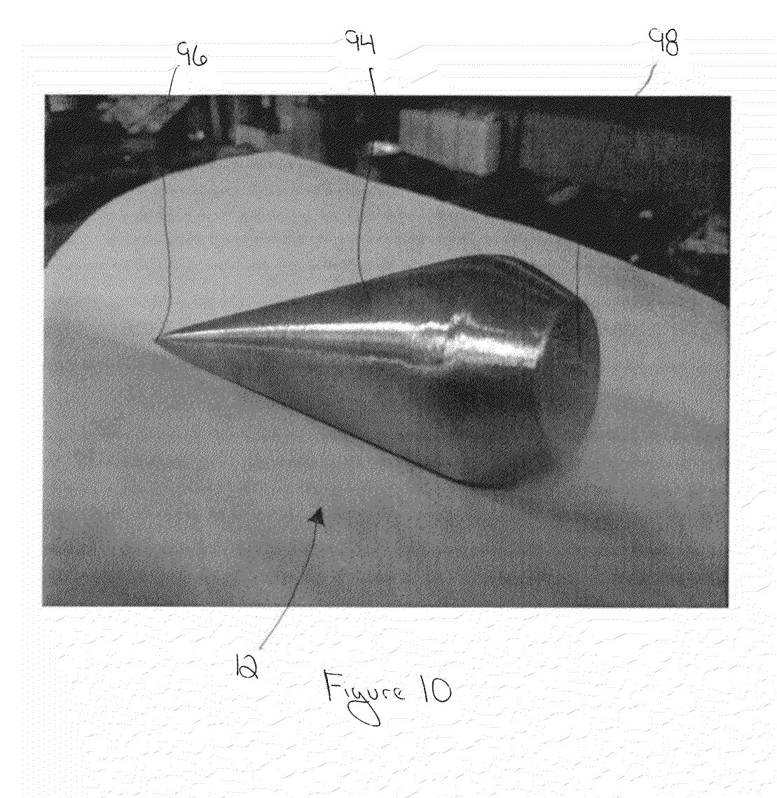

FIG. 10 is a top perspective view of still another exemplary embodiment of an exhaust insert 12 having a conical elongated body 94, a pointed first end 96, and a flat second end 98. Although various exemplary exhaust insert 12 shapes are provided in FIGS. 1-10, additional shapes may also be used. In addition, the size of the exhaust inserts 12 found in FIGS. 1-10 may be varied. Depending on the type and size of engine, the outside diameter of the exhaust inserts 12 may be between about 50% to about 90% of the inside diameter of the pipe in which the exhaust insert 12 is located. In still other exemplary embodiments the outside diameter may be approximately 70% to about 85% of the inside diameter of the pipe where the exhaust insert 12 is located.

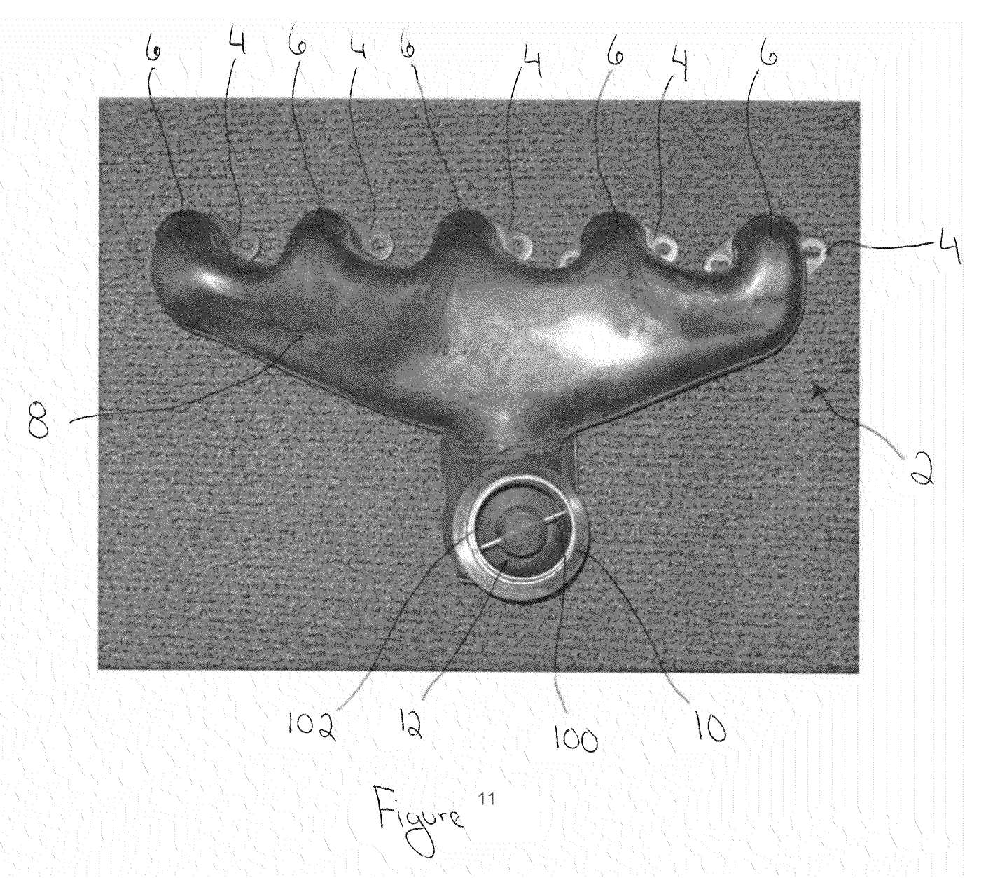

FIG. 11 is another exemplary embodiment of an original exhaust manifold 2. As shown in FIG. 11, the exhaust system includes a flange 4, conduits 6 and a collector 8. As with the exhaust manifold 2 in FIG. 1, the flange 4 is formed to the dimensions and shape of the engine (not shown in the Figures) to which it is to be attached. The flange 4 may be coupled to the engine with mechanical fasteners, such as bolts or rivets. The conduits 6 extend from the flange 4 to the collector 8. The flange 4 has openings therein to allow exhaust gas from the engine's cylinders to pass through the flange 4 and enter the conduits 6. The exhaust gas flowing through the separate conduits 6 enter one common flow path defined by the collector 8, having an exit aperture 10. From the collector 8, the exhaust gas passes through the exit aperture 10 and travels into the exhaust pipe which typically includes a catalytic converter 700 and exits the exhaust pipe through a muffler.

As shown in FIG. 11, an exemplary embodiment of an exhaust insert 12 is suspended in the exit aperture 10 by cross-members 100 and a collar 102. The collar 102 is shaped and sized so as to snuggly fit inside the exit aperture 10 of the collector 8. Although the exit aperture 10 in FIG. 11 has a circular cross-section, the cross-section may be rectangular, elliptical, or any other shape determined by the original manufacturer of the exhaust system. Likewise, the collar 102 may be shaped to provide a complimentary fit inside the exit aperture 10 of the collector 8. The cross-members 100 extend from the collar 102 and intersect with the exhaust insert 12; suspending the exhaust insert 12 inside the collar 102. As shown in FIG. 11, the exhaust insert 12 is suspended by two cross-members 100; however, it is contemplated that the exhaust insert 12 may be suspended by at least one cross-member 100. In other exemplary embodiments, the exhaust insert 12 may be supported by any number of cross-members 100. The cross-members 100 and the collar 102 may be constructed from metal, ceramic, plastic or any other material suitable to withstand the temperatures in a typical exhaust system.

The use of the collar 102 and cross-members 100 allows for easy insertion of the exhaust insert 12 into a pre-existing stock exhaust manifold 2. The collar 102 may be fixed to the exit aperture 10, collector 8, or conduits 6 to prevent movement of the exhaust insert 12. In addition, the exhaust insert 12 may be suspended in at least one of the individual conduits 6 running from the flange 4 to the collector 8. Locating the exhaust inserts 12 in the individual conduits 6 may provide more customizable tuning and better balance between engine performance and fuel efficiency. In embodiments wherein the exhaust insert 12 is suspended in the conduits 6, the collar 102 would be sized and shaped to fit securely inside the conduits 6. In other exemplary embodiments, the collar 102 may be used to suspend the exhaust insert 12 in any position along the exhaust system such as the conduits 6, before and after any collectors 8, before and after the catalytic converter(s) 700, before and after any Y-pipe(s), and at any location upstream from the exhaust tip. In addition, exhaust inserts 12 may be placed in series along the exhaust system so as to string together multiple exhaust inserts 12.

FIG. 12 is a perspective view of the exhaust insert 12 suspended in the collar 102 by cross-member 100. The exhaust insert 12 has a longitudinal axis including a conical body first end 110 and a cylindrical second end 18. While FIG. 12 illustrates the use of an exhaust insert 12 having a conical first end 110, it should be understood by those of skill in the art that the exemplary exhaust inserts 12 illustrated in FIGS. 1-10 may also be used in conjunction with the collar 102 and cross-members 100 found in the exemplary embodiment shown in FIG. 12.

In still other exemplary embodiments, the collar 102 may be movably inserted into the collector 8, conduit 6 or the exit aperture 10. In this embodiment, collar 102 may be affixed to a track inside the stock exhaust manifold 2. A series of servos may be used to move the collar 102, and thus the exhaust insert 12, upstream and/or downstream within the exhaust manifold 2. Sensors may be used to determine the engine RPM and pressures with the exhaust system. The sensors would send the data to control mechanism and in turn the control mechanism would interpret the data to determine if the exhaust insert 12 needed to be moved to dynamically optimize fuel efficiency, power or optimize emissions. Accordingly, the exhaust insert 12 may move upstream and/or downstream during wide open throttle driving and move upstream and/or downstream during slower engine RPM. In systems with multiple exhaust inserts 12 suspended within collars 102, each exhaust insert 12 may move independently from one another to optimize engine performance.

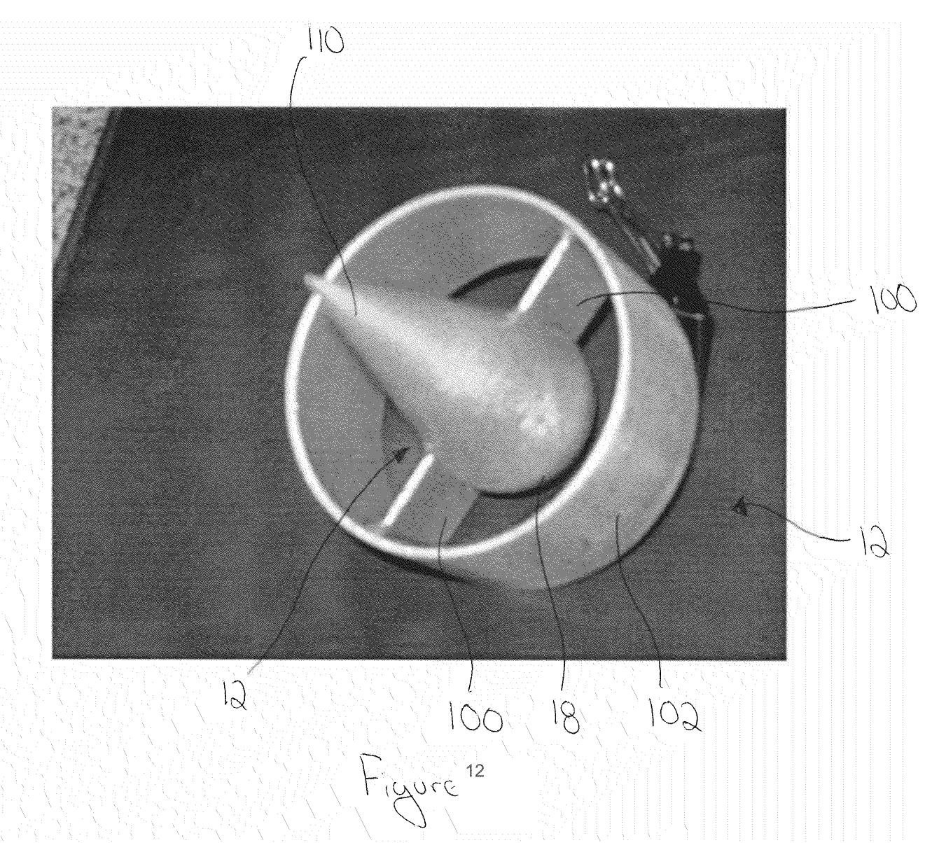

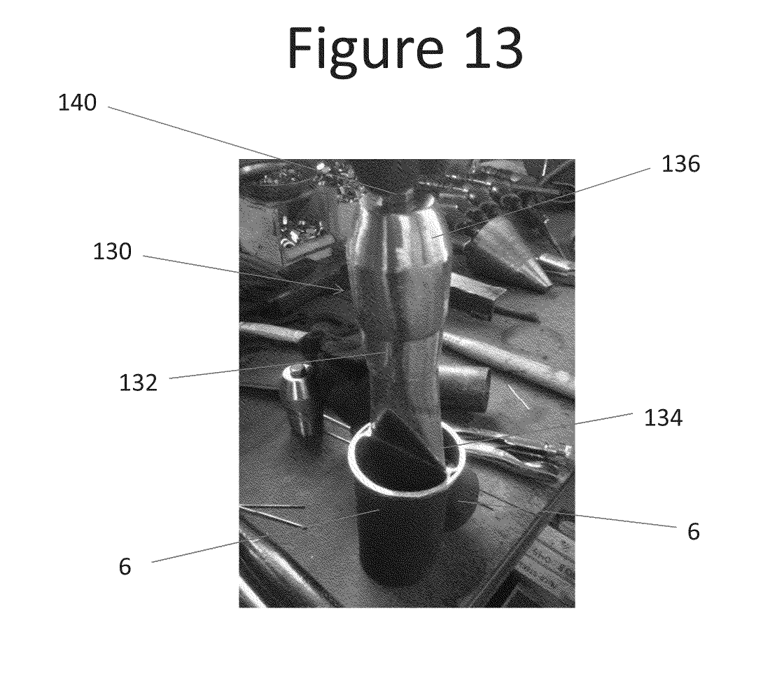

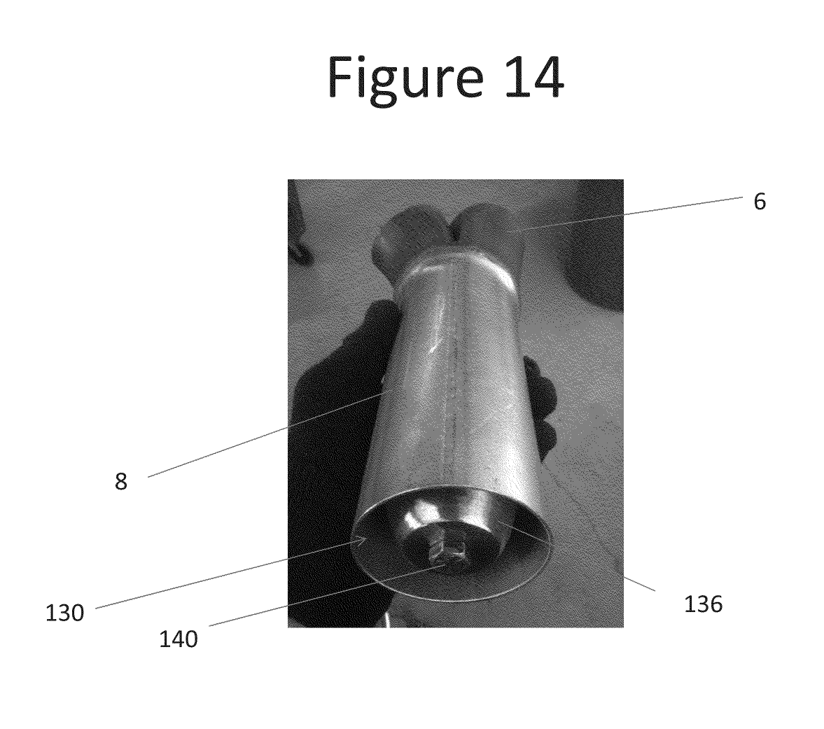

FIG. 13 and FIG. 14 show an exemplary embodiment of an adjustable exhaust insert 130 located in an exhaust system. As illustrated in FIG. 13, the adjustable exhaust insert 130 is affixed to the exhaust system at the junction of two conduits 6. In this embodiment, the exhaust insert 130 is welded to the conduits 6, but one of ordinary skill in the art would appreciate that exhaust insert 130 may be suspended inside the exhaust system by a collar 102 and cross-members 100 found in an exemplary embodiment shown in FIG. 12. The exemplary exhaust insert 130 has an elongated body 132 having a first end 134 attached to the exhaust system and a second end (not show in the Figures) adapted to be inserted into a series of variably sized outer shells 136. The outer shell 136 may be removably attached to the second end of the exhaust insert 130. The attachment may be accomplished by a mechanical fastener 140 or other similar device allowing removal of the outer shell 136 from the exhaust end. The ability to remove the outer shell 136 allows outer shells 136 of varying shapes and sizes to be attached to the second end of the elongated body 132 to optimize engine performance.

The exhaust inserts 12, 130 may be used with exhaust systems having original manufacturer's exhaust manifolds 2. The location of the exhaust inserts 12, 130 may vary depending on the size of the engine and to optimize various features of engine performance, such as fuel efficiency, engine power, and emissions. The exemplary exhaust inserts 12, 130 may be used with exhaust systems that have manifolds that are designed to not have one or more features such as a flange 4, conduits 6, or collectors 8. In exhaust systems without conduits 6, the exhaust inserts 12, 130 may be located directly at the exhaust port of the cylinder or at any other location within the exhaust system from the cylinder to the exhaust tip, such as before and after the catalytic converter 700, before and after the collector, before and after any Y-pipe in the exhaust system. In some other embodiments, the exhaust inserts 12, 130 may even be located between the catalytic converter 700 and the tail pipe of the exhaust system.

In other exemplary embodiments, the exhaust inserts 12, 130 may be used in a series or parallel arrangement within the exhaust system of an internal combustion engine. In these configurations, an exhaust insert 12, 130 may be located in at least one conduit 6, and another exhaust insert 12, 130 located in the collector 8, and possibly another exhaust insert 12, 130 downstream of the collector 8. In still other configurations, an exhaust insert 12, 130 may be located in each conduit 6. The above configurations are given as examples, and as such should not be considered limiting on the number of different configurations that may be employed to increase engine performance.

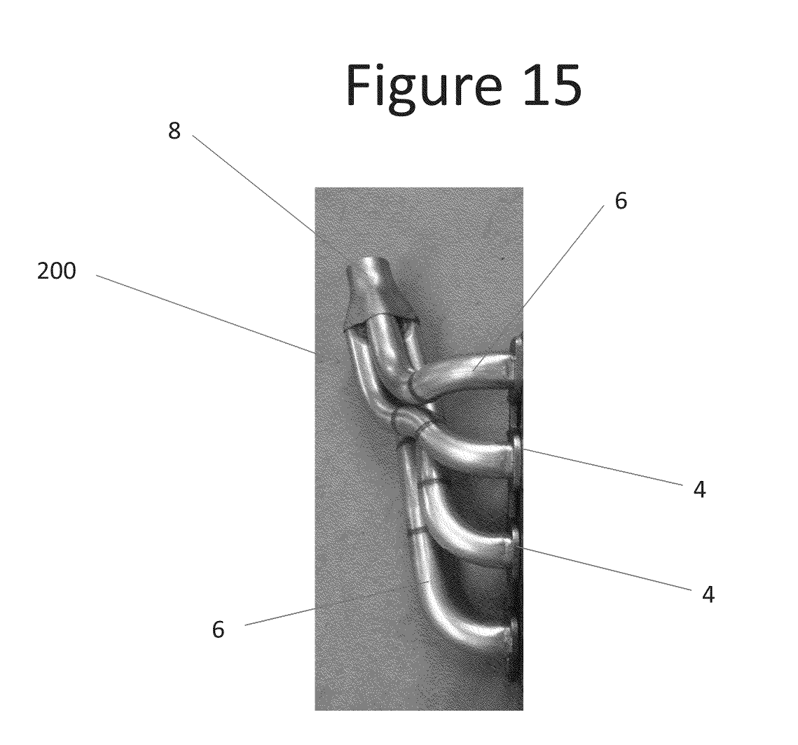

To take full advantage of the increased performance provided by the exhaust insert 12, 130 an exemplary exhaust manifold 200 may be used. As illustrated in FIG. 15, an exemplary embodiment of an exhaust manifold 200 may have a flange 4, sweeping conduits 6 and a collector 8. This exemplary exhaust manifold 200 provides multiple locations for exhaust insert 12, 130 placements versus exhaust manifolds 2 having no conduits 6, but rather a large collector 8. Therefore, the exemplary exhaust manifold 200 and the exhaust inserts 12, 130 form an exemplary exhaust system 202 that increase the performance of an internal combustion engine, including, but not limited to, increased fuel efficiency, increased engine power, and maintaining proper emission levels.

In order to confirm that the exhaust insert 12, 130 and exemplary exhaust manifold 200 increase the engine performance, including fuel efficiency, experiments have been conducted using a 2011 Dodge Ram pickup having a 5.7 liter V8 engine. The exhaust manifold of the Dodge Ram was replaced with an exemplary exhaust manifold 200. As discussed above, the exemplary manifold 200 provides a variety of locations for the placement of exhaust inserts 12, 130 versus the standard exhaust manifold 2 of the Dodge Ram. Exhaust inserts 130 where then placed in the exhaust manifold 200 to create an exemplary exhaust system 202. An exhaust insert 130 was placed in each collector 8 in the exhaust manifolds 200. In addition, another exhaust insert 130 was located where the two sides join together.

Exhaust plugs having a 1.75 inch outside diameter was used for the two exhaust inserts 130 located in each 2.5 inch collector 8. The third exhaust insert 130 located in a 3 inch pipe joining the two sides had an outside diameter of 2.25 inches. Before the installation of the exhaust inserts 130, the Dodge Ram was getting 21 to 23 miles per gallon at 60 miles per hour. After the installation of the exhaust inserts 130, the Dodge Ram's fuel efficiency increased approximately 21% to 26 to 28 miles per gallon. This is a significant increase in fuel efficiency while also increasing or maintaining engine power and maintaining proper emissions. It is precisely this increase in engine performance that was unexpected in standard internal combustion engines.

With the exemplary exhaust inserts 12 herein, both affixed to the exhaust system and suspended therein by collars 102, engine performance can be optimized by determining the proper number and location of the exhaust inserts 12. In addition, to optimize the engine performance at every RPM, both static and dynamic exhaust inserts 12 may be used. An example of one such arrangement for a V8 engine is used herein as an example of an exemplary system for optimizing engine performance utilizing the inventive exhaust inserts 12. In the example, an exhaust insert 12 is placed in each conduit 6 (8), one exhaust insert 12 is placed in each collector 8 (2), an exhaust insert 12 is placed before and after each catalytic converter 700 (4), and an exhaust insert 12 is present in the Y-pipe. Accordingly, this embodiment would consist of 15 exhaust inserts 12. If a triple Y-pipe configuration is implemented in the exhaust system of the vehicle then an additional four exhaust inserts 12 maybe added bringing the total to 19. Still yet, if it was determined that it was beneficial to utilize exhaust inserts 12 in series then the number would increase by X_{seq} number of exhaust inserts 12. In addition, it would be necessary to determine which of the exhaust inserts 12 were static and which were dynamic.

This above embodiment is an example and should not be used to limit the invention. The embodiment is given as merely an example of the possible number and combinations of exhaust inserts 12 that can be used in an exhaust system. Moreover, other embodiments contemplated therein may have greater or lesser number of exhaust inserts 12.

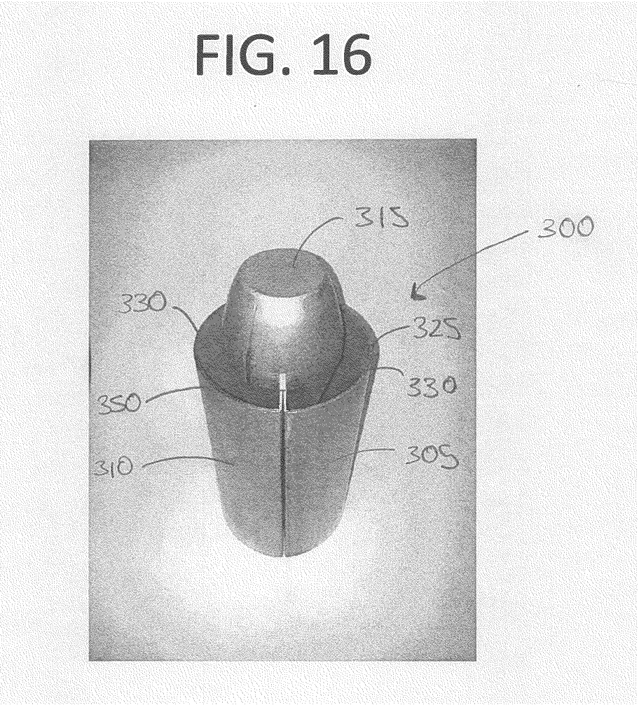

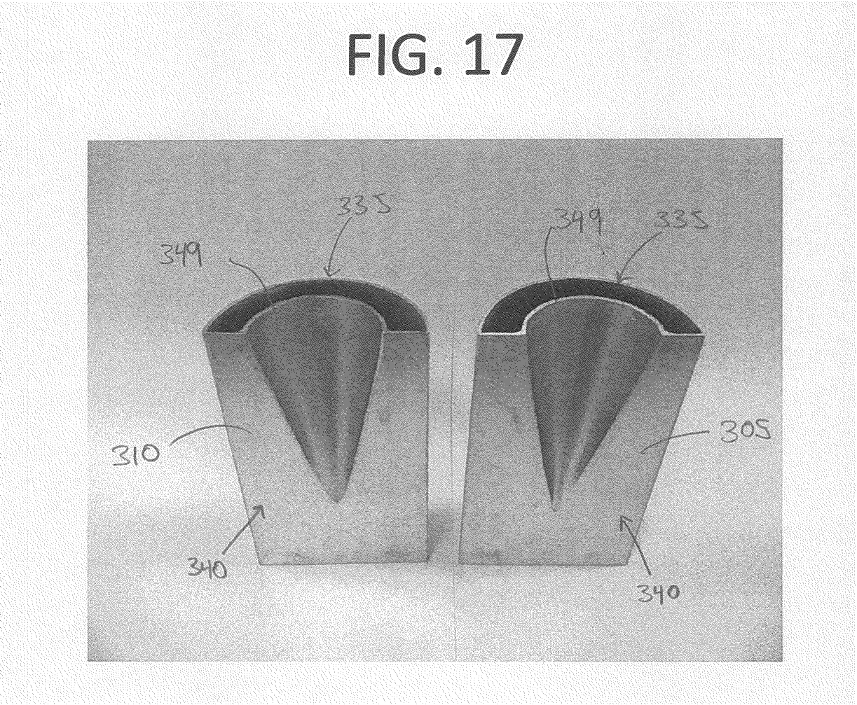

FIGS. 16-17 illustrate another exemplary embodiment of an insert 300. This insert may be formed by casting, molding, press, insert press, or other common methods utilized in the manufacturing of exhaust systems. The insert 300 is a joining of two negatives to form a positive shape within the exhaust system. In this embodiment, the insert 300 comprises a multi-part design having a first side 305, a second side 310, and an end cap 315. To form the insert 300, the first 305 and second 310 sides are brought together and fixed. The two sides may be welded using various methods (tack or spot, ultrasonic welding, friction welding, arc welding, gas welding, resistance welding, energy beam welding, solid state welding, or anything similar). The two sides could also be affixed to one another by other means such as adhesives, press fit, snap fit, bonding, or similar. Both the first 305 and second side 310 may start as circular tubes having a continuous circumference. Once the first and second sides 305, 310 are joined together and the insert body 320 is formed therein, the end cap 315 may be welded to the insert body 320 complete the insert 300. In other exemplary embodiments, the end cap 315 may be formed with the insert body 320 eliminating the need for a separate end cap 315.

Both the first and second sides 305, 310 have a rounded side coming together to form a collar 325. The circumference of the formed collar 325 may be sufficient to allow the insert 300 to be placed inside an exit aperture 10, collector 8, conduits 6 or any other position within the exhaust system. In other embodiments, the outside dimension of the collar 325 would be equal to the outside dimension of the exhaust pipe and welded into place. Once the first and second sides 305, 310 are brought together, channels 330 are formed through which the exhaust gas from the internal combustion engine flows. The insert 300 is preferably designed to allow for bidirectional insertion within the exhaust system.

FIG. 18 illustrates the first and second sides 305, 310 forming the insert 300. As illustrated the first and second sides 305, 310 are substantially identical to one another. In other words, it is preferred that the first and second sides 305, 310 are substantially symmetrical about a central plane. Each side 305, 310 preferably has a rounded outer surface 335 and a substantially planar inner surface 340. When the two sides 305, 310 are brought together the rounded outer surface 335 form a collar 325. In some embodiments, the collar 325 may have an outside dimension either slightly greater than or equal to the inside dimension of the exhaust pipe where the insert 300 is to be located. In this way, the insert 300 can fit within an existing exhaust pipe. In other embodiments, the collar 325 may have an outside dimension substantially equal to the outside dimension of the exhaust pipe where the insert 300 is to be located. In this way, the insert 300 can fit in line with existing exhaust piping, as it could be fastened between two existing exhaust pipes.

The substantially planar inner surfaces 340 each have half of the negative 349 of the conical portion 350 of the insert 300 formed therein. This negative 349 of the insert may be formed in a variety of ways including: casting, molding, pressing, stamping, insert press, or any other methods typical for formation of exhaust systems and related components. In other embodiments, the shape of the side 305, 310, including the negative 349 of the insert 300 may be formed by welding several pieces together. Although having only the conical portion 350 of the insert 300 formed therein, the end cap 315 may also be formed into the substantially planar inner surface 340 of the sides 305, 310. This forming of the end cap 315 into the substantially planar inner surface 340 would eliminate the need for a separate end cap 315, and its related assembly steps.

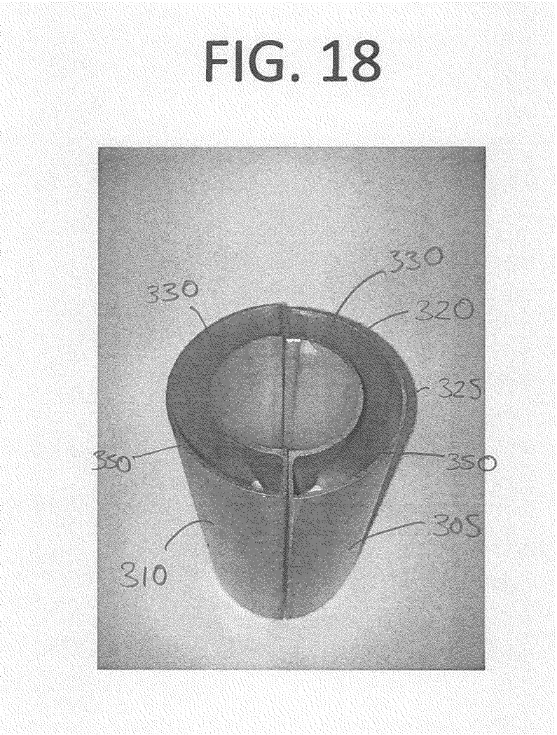

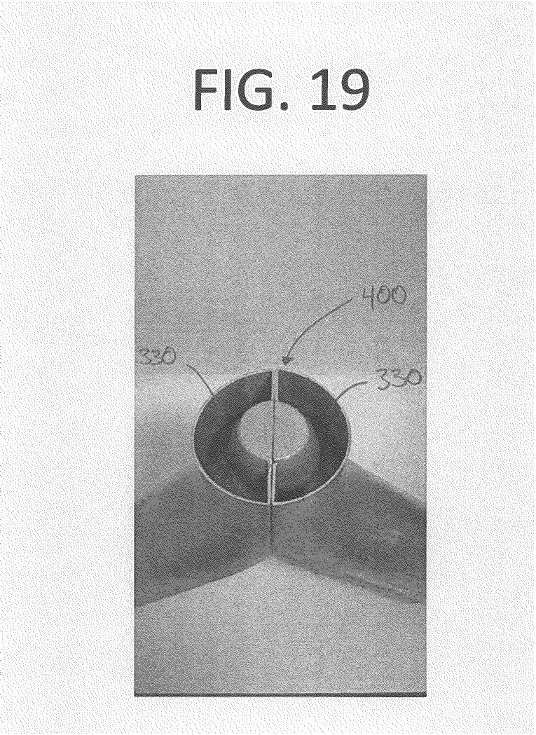

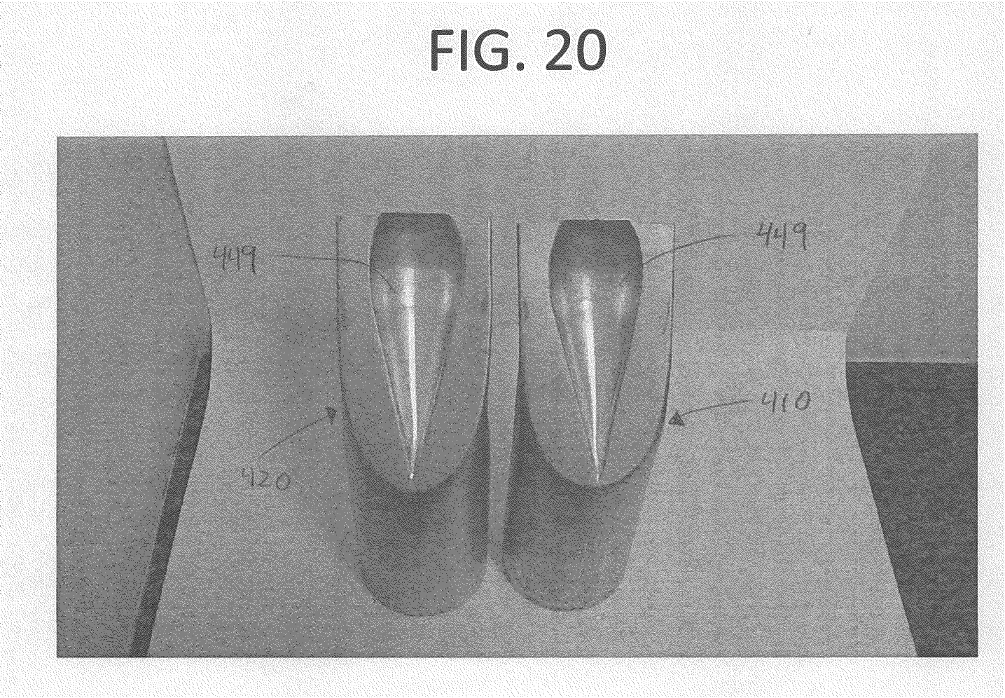

Another example of an insert 400 according to the inventive concept is provided in FIG. 19. As shown, the insert 400 is suspended in a Y-pipe creating channels 330 through which the exhaust travels. As with the embodiment shown in FIGS. 16-18, the insert 400 is created by placing two negatives 449 (shown in more detail in FIG. 20) together to create a positive shape within the exhaust pipe. The insert 400 may have any shape sufficient to result in increased engine performance and improved fuel efficiency, including the shapes provided herein related to inserts 12, 130. Since there is no need to actually weld the insert 400 into the exhaust system, this embodiment eliminates any potential concerns with inserts coming lose in the exhaust system.

FIG. 20 illustrates the components forming the insert 400. As shown, the insert 400 is formed from two nearly identical pieces of exhaust pipe forming a first side 410 and a second side 420. Each side is preferably formed from a single circular tube of exhaust pipe material. The side is then bent and then pressed to form a substantially planar inner surface 430. A negative impression 449 of half an insert 400 is then formed in the substantially planar inner surface 430. The negative impression 449 may be stamped, molded, cast, or pressed into the substantially planar inner surface 430. Once the negative impressions 449 are formed the two sides 420 and 410 are placed together as shown in FIG. 19 and joined. Similar to the referenced discussion of FIGS. 16-18 above, the two sides may be welded using various methods (tack or spot, ultrasonic welding, friction welding, arc welding, gas welding, resistance welding, energy beam welding, solid state welding, or anything similar). The two sides could also be affixed to one another by other means such as adhesives, press fit, snap fit, bonding, or similar.

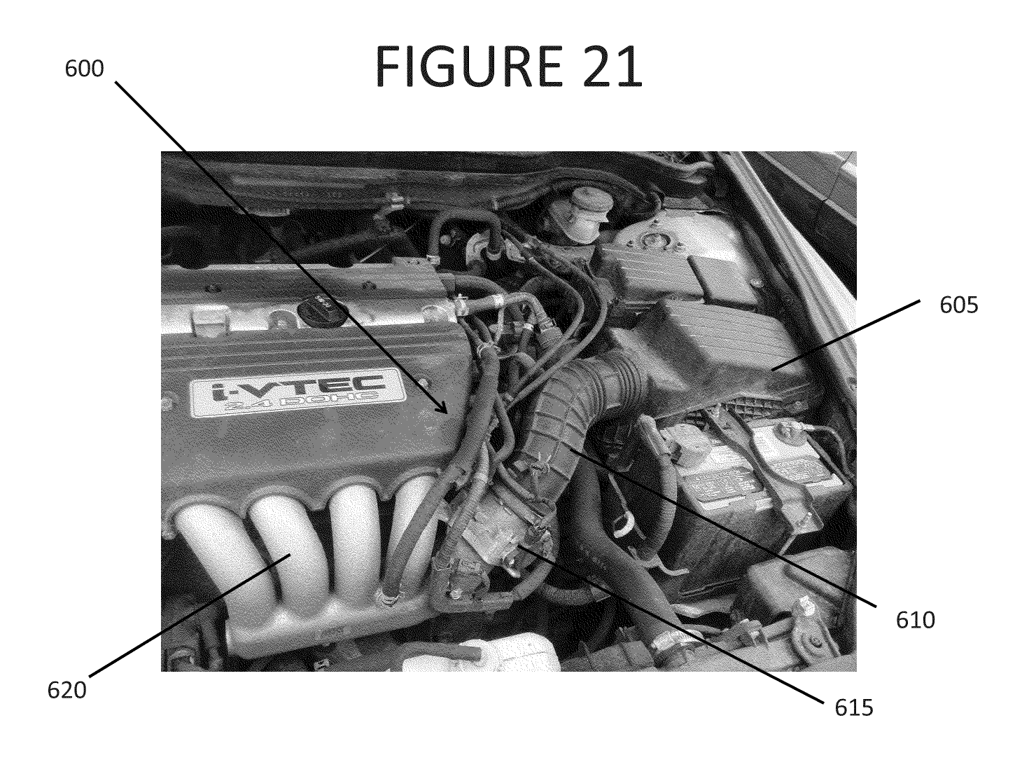

FIG. 21 illustrates an original manufacture intake system wherein the inserts described FIG. 1-20 may be inserted to increase engine performance and fuel efficiency. As seen in FIG. 21, the original manufacturer's intake system 600 includes a housing 605 for the air filter (not shown in the Figures), duct tubing 610, throttle body 615, intake manifold 620. The air enters the intake system 600 through a portion of the duct tubing referenced to as a snorkel (not shown in the Figure) located in the fender well. As indicated above, exemplary embodiments of the inventive concept have an insert 12, 130, 300, 400 placed within the intake system 600. The insert 12, 130, 300, 400 can be placed before the housing 605 in the snorkel portion of the intake system 600. The insert 12, 130, 300, 400 may be placed after the housing 605 in the duct tubing 610 between the housing 605 and the throttle body 615. The insert 12, 130, 300, 400 can be placed between the throttle body 615 and the intake manifold 620. The insert 12, 130, 300, 400 can be placed in the intake manifold 620 or in the intake ports of the engine (not shown in the Figures). In addition, multiple inserts 12, 130, 300, 400 can be placed in the intake system in series or parallel depending on location and desired performance and fuel efficiency.

As with other applications of the inserts 12, 130, 300, 400 described herein, the inserts 12, 130, 300, 400 for use in the intake system 600 may be made from a variety of materials such as, plastic, rubber, synthetic materials, silicone, metal, and other like materials sufficient to withstand the environments present in the intake system 600. The inserts 12, 130, 300, 400 may also be secured within the intake system 600 in the same manner as described herein for securing the inserts 12, 130, 300, 400 in the exhaust system. In addition, the inserts 12, 130, 300, 400 may be secured with bonding material for plastics, rubbers or other synthetic material sufficient to secure the inserts 12, 130, 300, 400 within the intake system 600. In addition, as described herein the insert 300, 400 may formed into from the components of the intake system 600. As described elsewhere, the insert 300, 400 may be formed negatives of the insert 300, 400 brought together to form a positive insert 300, 400 shape within the intake system. The shape of the insert 12, 130, 300, 400 could be any shape described herein and may be sized to provide specific engine performance or fuel efficiency.

In some embodiments, rather than having a static position within the intake system 600, the insert 12, 130, 300, 400 may be capable of movement within the intake system 600. Such a system would be similar to the system described with respect to exhaust systems placement of the inserts 12, 130. In embodiments with dynamic motion, the insert 12, 130, 300, 400 or inserts 12, 130, 300, 400 may be in communication with a servo or other similar device that is operated by a computer. The upon receiving instructions from the servo, the insert 12, 130, 300, 400 is moved within the intake system to optimize engine performance and fuel efficiency depending on the throttle position, altitude, or other factors affecting engine performance.

It should be noted that although FIGS. 16-20 show negative impressions which create a conical shape, this shape is not required and any number of the shapes shown in FIGS. 1-15 could also be used with these embodiments.

As mentioned herein the inserts 12, 130, 300, 400 can be positioned at any location in the exhaust system including before and after the catalytic converter 700. Directing attention to FIG. 22, a portion of the exhaust system is shown including a catalytic converter 700. FIG. 22 also has positions A and B representing possible positions of the inserts 12, 130, 300, 400. Position A represents any position upstream of the converter 700 and position B represents any position downstream of the catalytic converter 700. As noted the inserts 12, 130, 300, 400 can be positioned at A or B or both at both A and B. Moreover, multiple inserts 12, 130, 300, 400 can be placed at each location A and B. Such embodiments would be dependent on the exhaust flow through the exhaust system in order to optimize performance and fuel efficiency.

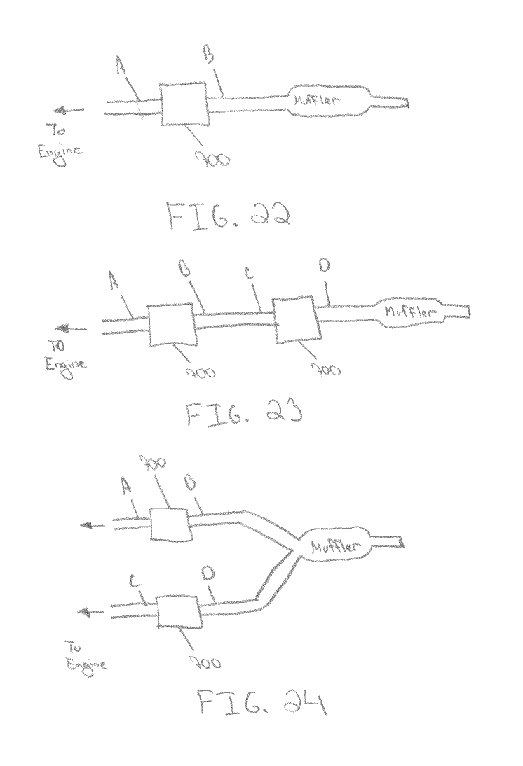

FIG. 23 illustrates a portion of an exhaust system having dual, in-line catalytic converters 700. As with FIG. 22, positions A, B, C, and D represent locations for the placement of an insert 12, 130, 300, 400. Accordingly, inserts 12, 130, 300, 400 or multiples thereof may be placed in the following locations A, AB, AC, AD, ABC, ABD, ACD, ABCD, B, BC, BD, BCD, C, CD, D or any other permutations thereof. The inserts 12, 130, 300, 400 may be sized according to ensure maximum engine performance and fuel efficiency.

FIG. 24 illustrates a portion of an exhaust system having dual, parallel catalytic converters 700. As with FIGS. 22-23, positions A, B, C, and D represent locations for the placement of an insert 12, 130, 300, 400. Accordingly, inserts 12, 130, 300, 400 or multiples thereof may be placed in the following locations A, AB, AC, AD, ABC, ABD, ACD, ABCD, B, BC, BD, BCD, C, CD, D or any other permutations thereof. The inserts 12, 130, 300, 400 may be sized according to ensure maximum engine performance and fuel efficiency.

With respect to FIGS. 22-24, the inserts 12, 130, 300, 400 may either be fixed in the exhaust system or may be moveable as described herein, depending on throttle position and gas flow. In addition, the inserts 12, 130, 300, 400 in FIGS. 22-24, may have any shape discussed herein, including, but not limited to those found in FIGS. 1-15. In addition, it should be recognized that the inserts 12, 130, 300, 400 can be placed in the exhaust system at an angle to increase engine performance and fuel efficiency. The angle may be between about 0 degrees and about 90 degrees. Moreover, the size and proportions of the inserts 12, 130, 300, 400 may be adjusted as well to increase engine performance and fuel efficiency. In addition, the inserts 12, 130, 300, 400 are reversible in the exhaust system. It is also noted that the embodiment illustrated in FIGS. 22-24 may also be used with each of the other embodiments found herein. Further, as indicated above, multiple inserts 12, 130, 300, 400 may be located at each position A, B, C, and D. In each embodiment, the distance the insert 12, 130, 300, 400 is from the catalytic converter 700 is determined by the engine size and output as well as the gas flow through the exhaust system.

Any combination of the exemplary embodiments described may be used herein. While certain exemplary embodiments of the present invention are described in detail above, the scope of the invention is not to be considered limited by such disclosure, and modifications are possible without departing from the spirit of the invention as evidenced by the following claims:

What is claimed is:

1. A system for improving the fuel efficiency of a combustion engine having an exhaust system defined by a first portion between cylinders and a collector, a second portion between the collector and a catalytic converter, and a third portion which follows downstream of the catalytic converter, the system comprising:
an exhaust insert placed within the second portion of the exhaust system.

2. The system of claim 1 wherein:
the insert has an outside diameter equaling approximately 50% to 95% of an internal diameter of the exhaust system where the exhaust insert is located.

3. The system of claim 1 wherein:
the exhaust insert has a conical shape.

4. The system of claim 1 wherein:
the exhaust insert is suspended within a collar that is placed within the exhaust system.

5. The system of claim 1 wherein:
the insert is created by forming a negative impression into an exhaust tube.

6. The system of claim 1 further comprising:
a second exhaust insert placed in the first portion of the exhaust system.

7. The system of claim 1 further comprising:
a second exhaust insert placed in the third portion of the exhaust system.

8. The system of claim 1 further comprising:
a second exhaust insert placed in the second portion of the exhaust system.

9. The system of claim 2 wherein:
the insert has an outside diameter which is less than an internal diameter of the exhaust system, where the outside diameter of the insert is chosen such that the fuel efficiency of the combustion engine is maximized.

10. A method for maximizing the fuel efficiency of an internal combustion engine having an exhaust system, the method comprising the steps of:
presenting a stock exhaust system which is attached to the internal combustion engine; and
placing an exhaust insert within the exhaust system in a location within the stock exhaust system that maximizes the fuel efficiency of the engine.

11. The method of claim 10 further comprising the steps of:
placing a second exhaust insert within the exhaust system in a location within the stock exhaust system that further maximizes the fuel efficiency of the engine.

12. The method of claim 10 wherein:
the stock exhaust system comprises a first portion between cylinders and a collector, a second portion between the collector and a catalytic converter, and a third portion which follows downstream of the catalytic converter and
the insert is placed within the second portion.

13. The method of claim 10 further comprising the steps of:
presenting a stock intake system which is attached to the internal combustion engine; and
placing an exhaust insert within the stock intake system.

14. The method of claim 10 wherein:
the stock exhaust system comprises a first portion between cylinders and a collector, a second portion between the collector and a catalytic converter, and a third portion which follows downstream of the catalytic converter and
the insert is placed within the second portion.

15. A system for improving the fuel efficiency of a combustion engine having an intake system, the system comprising:
an insert placed within the intake system.

16. The system of claim 15 wherein:
the insert is placed upstream of an air filter.

17. The system of claim 15 wherein:
the insert is placed downstream of an air filter.

18. The system of claim 15 wherein:
the insert is placed between a throttle body and an intake manifold.

19. The system of claim 15 wherein:
the insert is placed within an intake manifold.

20. The system of claim 15 wherein:
the insert has an outside diameter which is less than an internal diameter of the intake system, where the outside diameter of the insert is chosen such that the fuel efficiency of the combustion engine is maximized
